(19) United States
(12) Patent Application Publication
(10) Pub. No.: US 2018/0279600 A1
(43) Pub. Date: Oct. 4, 2018

(54) METHOD AND APPARATUS FOR REPELLING INSECTS

(71) Applicant: Baron L. Tayler, Harrisburg, PA (US)

(72) Inventor: Baron L. Tayler, Harrisburg, PA (US)

(21) Appl. No.: 15/866,572

(22) Filed: Jan. 10, 2018

Related U.S. Application Data
(60) Provisional application No. 62/478,079, filed on Mar. 29, 2017.

(51) Int. Cl. A01M 29/08; A01M 29/10

(52) U.S. Cl. CPC A01M 29/08; A01M 29/10

(57) ABSTRACT

A method and apparatus for repelling insects with compound eyes employs diffraction gratings formed in movable structures, such as conventional compact discs (CDs), to create moving diffraction patterns of light from ambient light, or light from specially provided light sources, impinging on the gratings. The CDs may be suspended in a housing or frame that may be open at its sides or closed by transparent glass or plastic walls. For open sided housings the suspended CDs may be caused to turn or twist by ambient air currents or by a motor located in the housing and connected to rotate or turn the CDs. When the housing is fully closed, the motor drive effects movement of the CDs. The resulting moving light diffraction patterns repel insects having compound eyes.

### CROSS REFERENCE TO RELATED APPLICATIONS

The present application claims priority from and is a non-provisional application of U.S. Provisional Application No. 62/478,079 entitled “Flying Insect Repellant Device”, filed Mar. 29, 2017, the disclosure of which is hereby incorporated by reference in its entirety.

### BACKGROUND

### Technical Field

The present invention pertains generally to methods and apparatus for repelling insects and, more particularly to the use of moving light patterns to repel flying insects having compound eyes, such as houseflies, from a selected environment.

### Discussion of the Prior Art

Flying insects are a world-wide annoyance and health menace and are generally attracted to locations of human activity by food, sources of heat, moisture and areas lending themselves to quick development and breeding of bacteria. Flying insects land on and come into contact with a wide range of pathogens and decaying organic substances, in search of either food or a place to lay their eggs, and subsequently transfer bacteria or disease from those substances to the next landing place. Therefore, the spread of bacteria or disease from flying insects coming into contact with human food or human surroundings is a major health concern. In addition, numerous flying insects, such as mosquitos and horseflies, inflict bites and, in doing so, may transfer pathogens from their biting apparatus into the human subject. Still other insects, such as bees and wasps, inflict painful stings, with the possibility of causing anaphylactic reactions in the stung subjects, which may result in death.

The insect repellant device of the present invention is designed to repel flying insects of the type having compound (i.e., multi-faceted) eyes. Houseflies, horseflies, bluebottle flies, bot flies, black flies, bees of all varieties, and wasps of all varieties are examples. These types of insects become confused and frightened by certain light patterns because the compound structure of their eyes, which typically consist of between 3,000 and 7,000 tiny independent light receptor lenses (or facets called ommatidia) that are directed over an almost 360° field of view, causes the fly to see thousands of images simultaneously without depth perception and with extreme short-sightedness. However, flies can visually sense form, movement and reflections more acutely and over a broader field of view than can humans. Also, while humans can visually perceive approximately fifty to sixty images per second, flying insects can perceive images at more than twice that rate. As an object moves across the fly's field of view the ommatidia successively fire and stop firing in what is called a flicker effect which is similar to how a scrolling marquis functions with lights turning on and off to provide an illusion of motion. Because a fly can easily see motion and form, but not necessarily what the large moving object is, they are quick to flee, even if the moving object is harmless. More specifically, it is believed that flying insects with compound eyes visually perceive the shifting of light as a potential predator, causing fear, with the result that they depart the area or space where the light patterns exist.

It is known in the prior art to use the refractive properties of transparent liquid to repel flies and other flying insects having compound (i.e., multi-faceted) eyes. For example, U.S. Pat. No. 6,543,189 (Pace) discloses suspending transparent containers of transparent liquid from a ceiling or beams in a covered environment to repel houseflies. Pace also discloses a method of hanging multiple such containers around the perimeter of a structure open at its sides, or near doors or other openings when the structure is partially enclosed along its sides. The suspended containers swing slightly as a result of breezes, and ambient light passing through the liquid is refracted; the resulting moving light patterns are said to repel flies.

In US2015/0027032 (Batten II) there is disclosed an apparatus comprising a stationary transparent container of clear liquid that is said to repel flies by refraction of ambient light through the stationary liquid.

U.S. Pat. No. 9,538,742 (Jacobson) discloses a water-filled transparent container that is adapted to be suspended from a ceiling and has a multi-faceted bead suspended therein. The multiple reflections from the bead facets, refracted through the water, are said to frighten and repel flies.

Although these prior approaches to repelling flies appear to have some effect, I have found that such effect is less than optimal and that what has been ignored in these prior approaches to insect repellance is the use of light redirection caused by a moving diffraction grating which diffractively splits and randomly redirects light into its several constituents.

### OBJECTS AND SUMMARY OF THE INVENTION

Therefore, in light of the above, and for other reasons that become apparent when the invention is fully described, it is an object of the present invention to provide methods and apparatus for more efficiently and effectively repelling flying insects that have compound eyes.

It is another object of the invention to provide improved techniques for creating moving diffractive light patterns that optimally repel flying insects of the type having compound eyes.

A further object of the invention is to provide a moving diffracted light spectrum pattern that has a greater effect in repelling flies than is achieved with refracted light devices in the prior art.

The aforesaid objects are achieved individually and in combination, and it is not intended that the present invention be construed as requiring two or more of the objects to be combined unless expressly required by the claims attached hereto.

It is understood that the surface of a diffraction grating is covered with concentric grooves, and that light striking the grooves is scattered or dispersed in diffraction patterns in virtually all directions. More specifically, a diffraction grating separates incident polychromatic (or “white”) light into constituent wavelength components (i.e., it is dispersive), and each wavelength of the input light spectrum is sent in a different direction, producing a dispersed array of colored light. With the foregoing objects in mind, if the diffraction grating is moved, either by air currents or by a motor drive, the dispersed diffraction patterns of the light constituents are moved or swept accordingly. I have found that these moving diffraction patterns are highly disturbing and threatening to flies and other insects having compound eyes.

Accordingly, in one aspect of the invention a moving diffraction grating is used to repel insects having compound eyes by diffracting light into moving diffraction patterns of multiple separated components of different wavelengths in an environment to be protected. The diffraction grating device may be housed in a standalone unit that can rest on a surface or be suspended in the protected environment. In a preferred embodiment the diffraction grating device is comprised of an assembly of at least one and preferably two or more compact discs, each suspended with its planar sides oriented such that the disc assembly is free to rotate about a common diametric axis passing through each disc and coplanar with the disc surfaces. If multiple discs are employed they are suspended one above the other with the planes of the discs oriented at different angles (e.g., 90°) about the rotation axis. In the specific disclosed embodiment the discs are mutually connected so that they rotate in unison; however, it is contemplated that the disc mounting can be such that each disc is free to rotate independently relative to the others about the common axis. Ambient white light impinging on the discs, or alternatively a light beam from a provided light source directed at the discs, produces a reflective diffraction pattern as a result of the diffraction gratings formed on the discs. Rotation of the discs, either by ambient air currents or by motor drive, causes the multi-component diffraction patterns to correspondingly sweep the surrounding space. This has been found to provide a far greater repellent effect on insects with compound eyes than simple stationary or moving reflective or refractive light patterns.

Although vertical suspension of the diffraction gratings is the preferred embodiment of the invention, it is to be understood that one of more gratings can be mounted to be rotatable (e.g., by ambient breeze or motor drive) about an axis of any orientation (e.g., horizontal) to produce the moving diffraction patterns that cause the desired fear in flies and other insects having compound eyes.

The diffraction provided according to the invention may be provided by any device having a diffraction grating on one or more of its surfaces, and the diffraction may be of the reflective or refractive type, depending on the material in which the diffraction grating is formed and on the transmissivity of that material to the light being diffracted.

The above and still further features and advantages of the present invention will become apparent upon consideration of the definitions, descriptions and descriptive figures of specific embodiments thereof set forth herein. In the detailed description below, like reference numerals in the various figures are utilized to designate like components and elements, and like terms are used to refer to similar or corresponding elements in the several embodiments. While these descriptions go into specific details of the invention, it should be understood that variations may and do exist and would be apparent to those skilled in the art in view of the following description.

### BRIEF DESCRIPTION OF THE DRAWINGS

FIG. 1 is a side view in perspective from above of a first embodiment of the present invention.

FIG. 2 is a side view in perspective from below of the embodiment of FIG. 1.

FIG. 3 is a front view in elevation of the embodiment of FIG. 1.

FIG. 4 is a partially diagrammatic view in perspective from above of the embodiment of FIG. 1 depicting the rotational effect of air currents on the illustrated unit.

FIG. 5 is a partially diagrammatic view in perspective from above of the embodiment of FIG. 1 depicting the effect of the unit on flying insects.

FIG. 6A is detailed partial view of the top of the embodiment of FIG. 1 showing its top compartment door open and the compartment empty.

FIG. 6B is detailed partial view of the top of the embodiment of FIG. 1 showing its top compartment door open and the compartment containing a motor for operating the unit.

FIG. 6C is detailed partial view of the bottom of the embodiment of FIG. 1 showing its bottom compartment door open and the compartment containing items for supporting the unit.

FIG. 7 is a side view in perspective from above of a second embodiment of the present invention with suction cups attached for mounting the unit on a wall.

FIG. 8 is a front view in perspective from above of a third embodiment of the present invention.

FIG. 9 is a perspective view of a connector used to interconnect two compact discs in the various embodiments of the invention.

### DESCRIPTION OF THE PREFERRED EMBODIMENTS

Specific dimensions set forth below are by way of example for particular embodiments to assist in an understanding of the illustrated structure; these dimensions are not to be construed as limiting the scope of the invention.

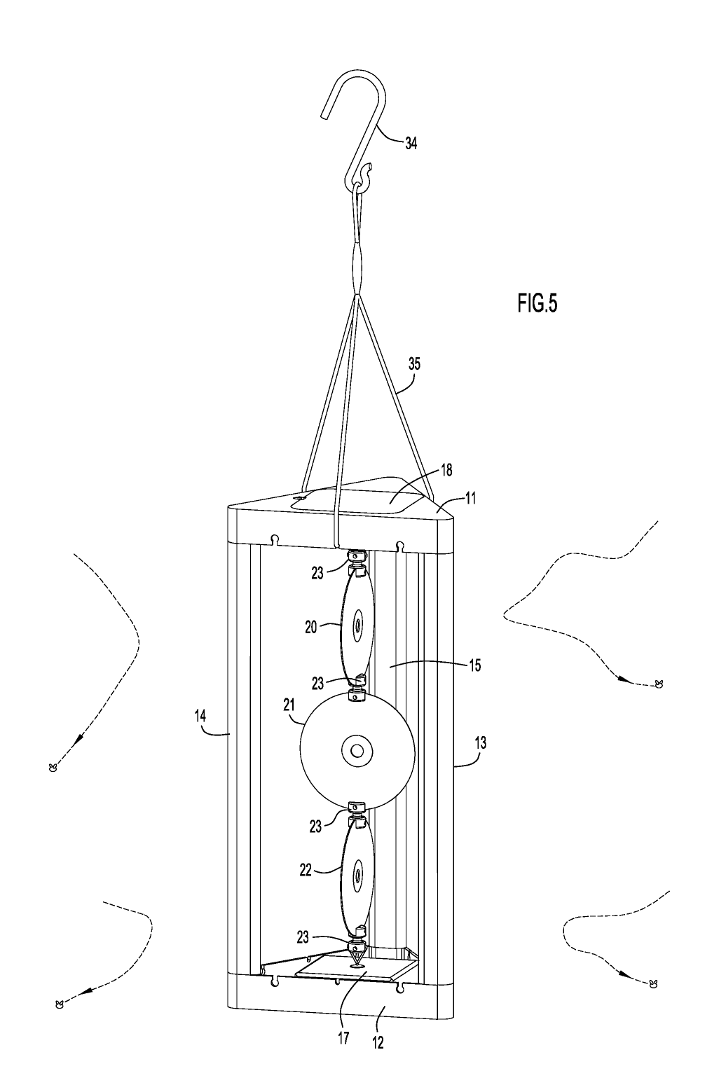

The preferred embodiments of the invention described below utilize diffraction gratings formed in movable structures, such as conventional compact discs (CDs), to create moving diffraction patterns of light from ambient light, or light from specially provided light sources, impinging on the gratings. The CDs may be suspended in a housing or frame that may be open at its sides or closed by transparent glass or plastic walls so that the moving diffraction patterns can pervade the three dimensional space surrounding the housing for the purpose of repelling insects having compound eyes as diagrammatically illustrated in FIG. 5. For open sided housings the suspended CDs may be caused to turn or twist by ambient air currents, or by a motor located in the housing and connected to rotate or turn the CDs. When the housing is fully closed, however, the motor drive is required to effect movement of the CDs. The effected movement is typically angular back and forth movement through relatively small angles; however, providing for continuous movement in one angular direction is within the principles of the invention. Importantly, the invention creates moving light diffraction patterns that repel insects having compound eyes.

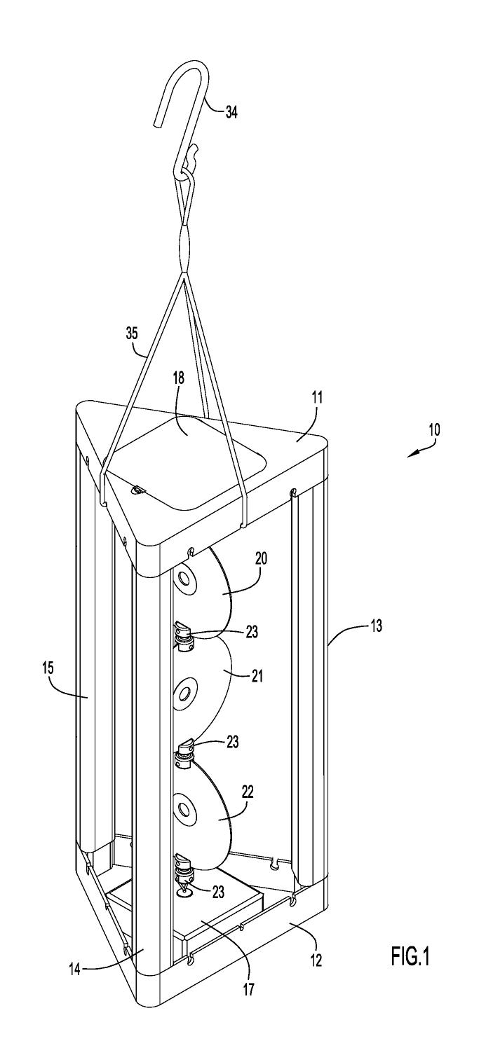

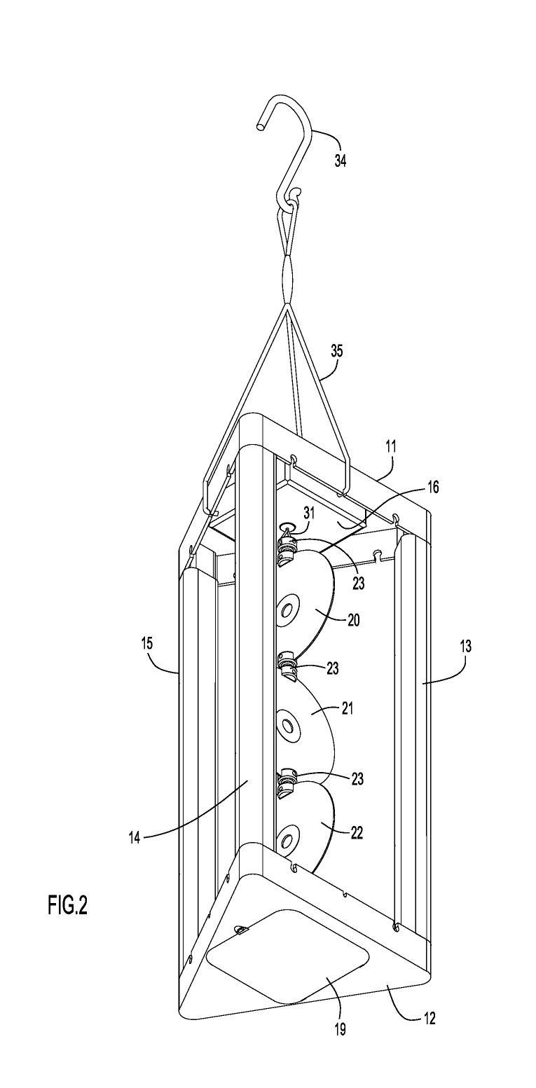

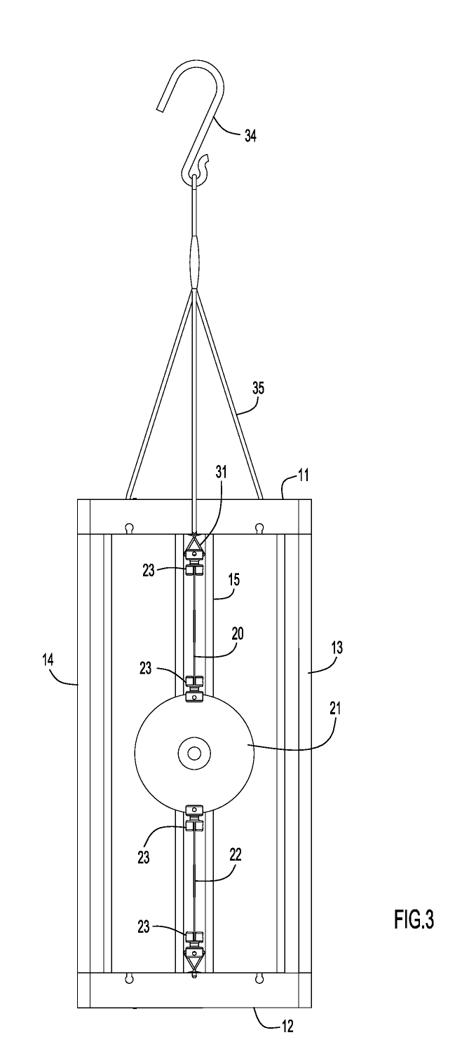

Referring specifically to FIGS. 1-7 and 9, a preferred embodiment of the invention includes a housing or frame 10 comprising a top cover 11 having a triangular base wall with a short triangular peripheral sidewall depending from its edges, and a bottom cover 12 having a similar triangular base wall with a short triangular peripheral sidewall extending upward from its edges. Three angularly spaced support posts 13, 14, 15 extend in mutually parallel relation between respective pairs of vertices of the top and bottom covers to define the housing frame 10 having a triangular prism configuration. In the preferred embodiment the three sides of the housing are open; however, it is to be understood that, for some embodiments, the sides may be closed with panels of transparent glass or plastic. It is also to be understood that the triangular prismatic configuration is efficient and effective for the preferred embodiment, but any polyhedral or cylindrical configuration may be used. Likewise, any number of support posts may be provided.

A top compartment 16 may be integrally formed with or secured to the interior surface of top cover 11, and a bottom compartment 17 may be integrally formed with or secured to the interior surface of bottom cover 12. The interior of top compartment 16 is accessible via a top access panel 18 that may be hinged or removably secured to top cover 11 at an access opening at the top surface of top cover. The interior of bottom compartment 17 is accessible via a bottom access panel 19 that may be hinged or removably secured to bottom cover 12 at an access opening at the bottom surface of the bottom cover.

Three diffraction gratings 20, 21, 22 are secured at their edges to one another by connectors 23 in a cascade assembly such that each grating is oriented at an angle different from the immediately adjacent grating. The cascade assembly is suspended between compartments 16 and 17 in a manner that permits rotation of the gratings. In the illustrated preferred embodiment the diffraction gratings are conventional circular compact discs in which the gratings are defined in one or both surfaces. A typical such disc has a diameter of 12 cm and a thickness of between 1.1 mm and 1.5 mm, and the material is reflective so that the diffraction produced by the grating is reflective rather than refractive. It will be understood, however, that non-reflective material that is refractive to light may be employed to provide refractive diffraction from gratings in other embodiments of the invention. It will be further understood that the discs employed in the unit as diffraction gratings can have substantially any diameter and thickness consistent with the functions described herein, and that the diffraction gratings need not be disc-shaped but instead can have any configuration consistent with said functions.

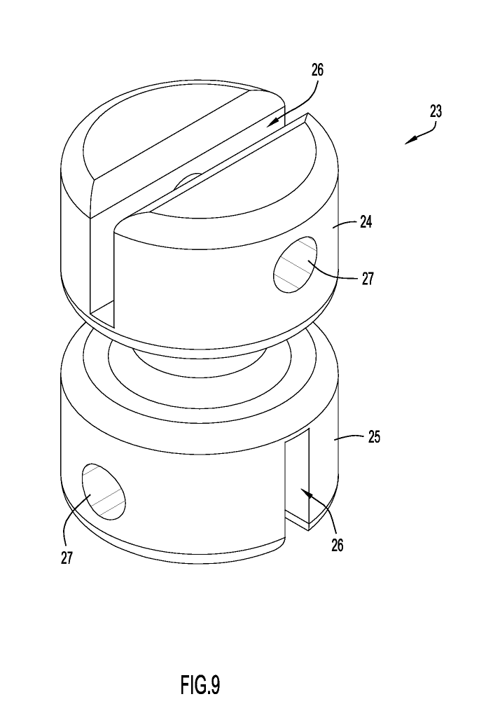

Connector 23 is illustrated in FIG. 9 and includes two substantially identical hubs 24, 25 which, in the preferred embodiment, are configured as coaxial cylinders secured to one another in fixed angular relation. Each hub has a slot 26 defined diametrically therethrough in its surface facing remotely from the other hub, and a generally cylindrical through-hole 27 extending diametrically therethrough and in perpendicular intersecting relation with slot 26. When connector 23 is used to interconnect two discs, e.g., upper disc 20 and intermediate disc 21, a portion of the edge of the upper disc 20 is inserted into the upward facing slot 26 of upper hub 24, and a similar portion of the edge of intermediate disc 21 is inserted into the downward facing slot 26 of lower hub 25. Discs 20 and 21 are thusly secured to one another in fixed 90° angular relation about the common rotation axis of the unit. Likewise, a connector 23 is used to interconnect intermediate disc 21 and lower disc 22, with the result that successive discs are turned by 90° relative to one another, and the three-disc assembly is rotatable as a unit. In this manner the reflective surfaces of the discs with the gratings defined therein face in mutually different directions, separated by 90° in the illustrated example.

It will be appreciated that connectors 23 may be replaced by swivel members that permit adjacent discs to rotate relative one another whereby each disc in the assembly would be independently rotatable. The discs may be secured in the respective slots in any of several manners. For example, a hole may be defined through the disc at a position to be aligned with through-hole 27 when the disc is inserted edgewise into the slot so that a screw, bolt, compression or split pin can be inserted through the hole 27 and the disc hole to secure the disc to its respective hub. Alternatively, the discs may be secured by adhesive, or the like, in respective slots. Whatever the attachment means, each disc is secured to a hub (e.g., hub 24) and is rotatable therewith.

A connector 23 may be used to connect the uppermost disc 20 to top cover 11 at the bottom of compartment 16. Specifically, a rotation cord or chain 31 may be secured to the upper hub 24 with its end secured in compartment 16. Securing the rotation cord 31 to hub 24 may be effected by means of adhesive, or the like, in slot 26 of hub 24, or by threading the cord through the through-hole 27 of hub 24. In this manner the three assembled discs 20, 21, 22 are suspended in a vertical cascade configuration that is free to rotate or twist about an axis extending diametrically through each of the discs. The lowermost disc 22 may be similarly secured to the bottom compartment 17 by a connector 23 to maintain the entire cascaded disc assembly and its axis in taut parallel relation to the frame posts 13, 14, 15. Although connector 23 is quite efficient in permitting the CDs 20, 21, 22 to be suspended as described, it is to be understood that other commonly available mechanisms may be employed for the same purpose.

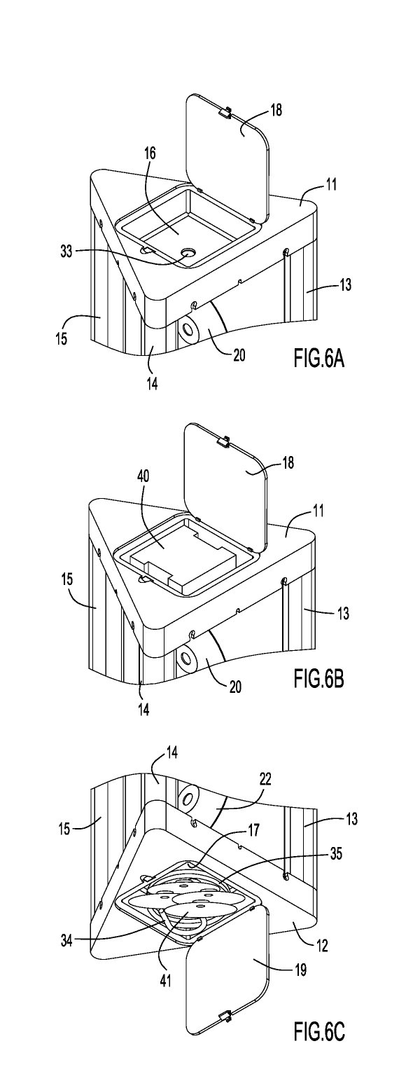

As shown in FIG. 6A, the top compartment 16 may have an aperture 33 in its bottom wall suitable for the upper end of rotation cord 31 to be extended through and secured in the compartment to permit air current actuated rotation of the disc assembly. Alternatively, a motor may be secured in compartment 16 with a drive shaft extending through aperture 33 and configured to engage and rotate the disc assembly. More specifically, referring to FIG. 6B, the top compartment 16 may house motor 40 configured to positively rotate the cord/chain 31. The motor is conventional and may be electrically operated by a battery or by AC voltage. Typical battery-operated motors that may be used for this purpose are disclosed in U.S. Pat. No. 2,814,769 (Williams) or U.S. Pat. No. 4,029,980 (Gamble), the disclosures in which are incorporated herein in their entireties. Alternatively, the motor 40 may be a conventional spring motor driven by a spring that is manually wound and selectively released for rotation of the disc assembly, such as, for example, the spring motors described and illustrated in U.S. Pat. No. 4,135,329 (Kennedy), U.S. Pat. No. 5,590,741 (Storms) or U.S. Pat. No. 7,874,343 (Hansen), the disclosures in which are incorporated herein in their entireties.

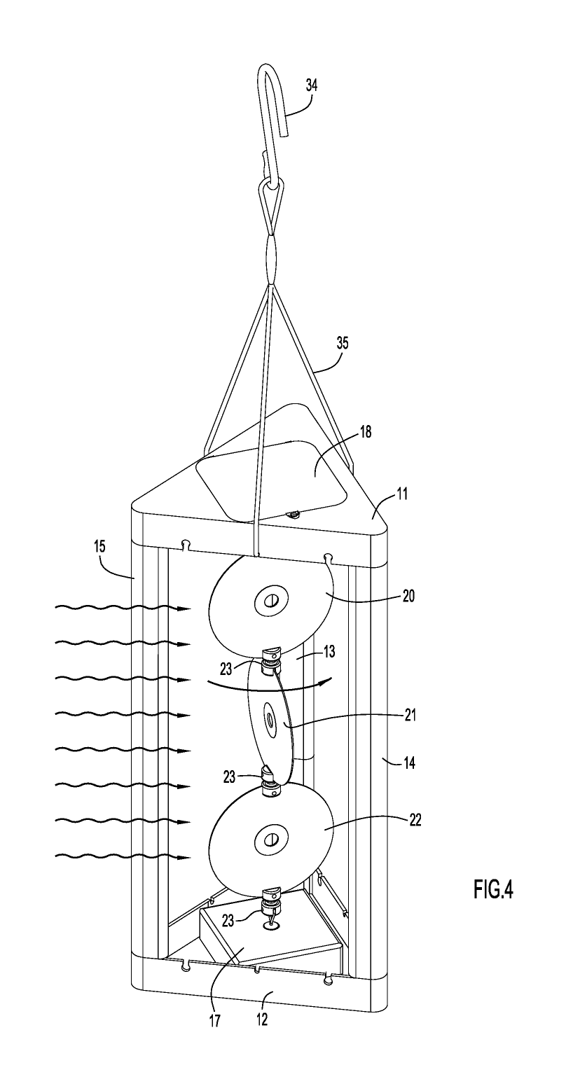

As described, the invention functions properly to repel flies and other insects when the disc assembly is free rotate randomly through small angles in either direction under the influence of ambient breezes or air currents as illustrated diagrammatically in FIG. 4. However, as also described, it is well within the scope of the invention to effect such angular motion using positive motor drive with motor 40 wherein the motor drive shaft extends through aperture 33 and is secured to the cord/chain 31 so that as the motor shaft rotates about the rotation axis of the disc assembly, the cord/chain 31 is caused to likewise rotate. This rotation may be continuous in one direction or oscillatory through small angles in opposite directions. Such motor drive may be used whether the sides of the housing are open or closed, but motor drive is necessary in embodiments wherein the sides of the housing between posts 13, 14 and 15 are closed by transparent glass or plastic walls.

The drive motor may alternatively be located in bottom compartment 17 in the bottom cover member 12, although in the preferred embodiment, as illustrated in FIG. 6C, the bottom compartment primarily serves as a storage space for a housing support cord or chain 35 and a hook 34 attached thereto for suspending the housing 10 from a ceiling or rafter as shown in FIGS. 1-5. As shown, support cord 35 includes three segments joined at their upper ends to hook 34 and terminating at their lower ends in grapples that engage respective sections of the peripheral sidewall of top cover 11. In this regard the sidewall may be provided with slots, as shown, to facilitate engagement of the cover by the grapples.

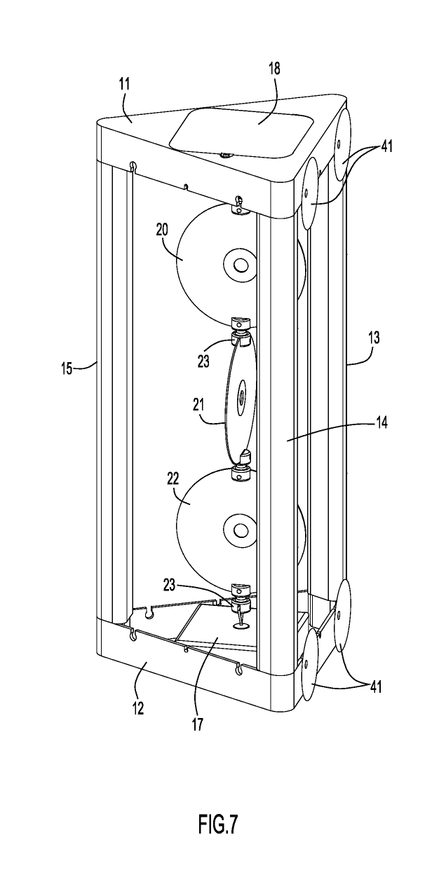

Further, as shown in FIG. 6C, bottom compartment 17 may serve to house suction cups 41 used to mount the unit on a wall as illustrated in FIG. 7 described below.

It will be noted that the housing need not be suspended above the ground but can instead rest on a surface, such as a table, with the bottom cover 12 resting on that surface. Alternatively, as illustrated in FIG. 7, the housing may be supported on a wall or other vertical surface by means of suction cups 41, or other wall mounting means, such as hook or nail receiving apertures defined in one or both covers 16, 17.

As described above, the discs are secured to one another such that the reflective surfaces of the discs face in mutually different directions, typically but necessarily spaced by 90°. Thus, as they assembly rotates the resulting reflective diffraction patterns are angularly separated relative to the rotation axis and are effectively swept through the entire surrounding area. It will be understood that the discs can be positioned at other than 90° relative to one another. For example, the diffraction surfaces of the three discs may be angularly spaced by 120°; or if only two disc are used the angularly spacing between their diffraction surfaces may be 180°.

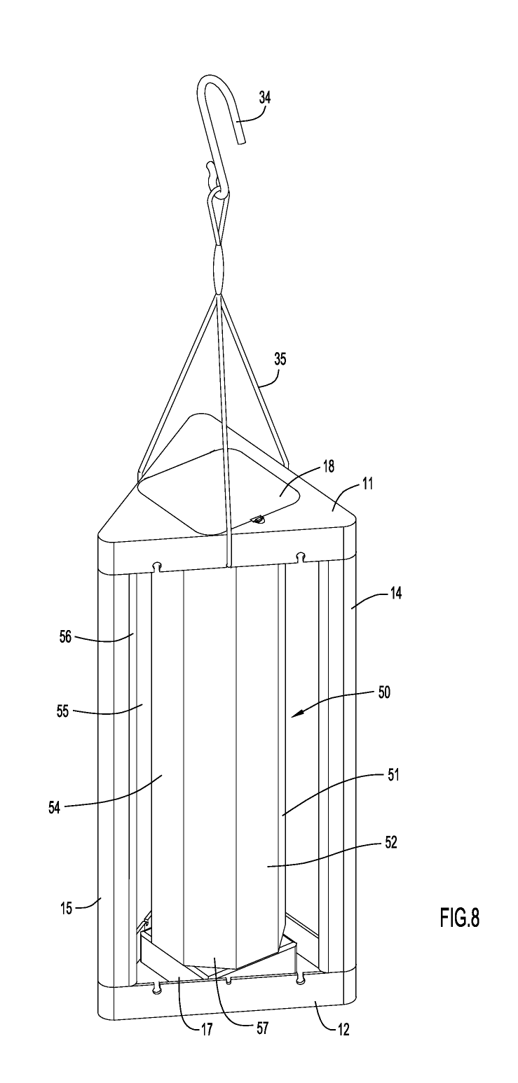

Although the preferred embodiment of the invention employs conventional compact discs to provide the movable diffraction gratings, any structure with a defined diffraction grating may be employed. One example is shown in FIG. 8 wherein a diffraction unit 50 in the form of a polyhedron is suspended in housing 10 and has diffraction gratings defined in each of its faces or facets, e.g., facets 51, 52, 53, 54, 55 and 56. The facets may be reflective, in which case reflective diffraction occurs when light is incident thereon. Alternatively the facets may be partially or primarily transmissive of light, in which case the gratings produce refractive diffraction. As a still further alternative, some facets may be reflective and some transmissive so that structure 50 produces a combination of reflective and refractive diffraction patterns. Diffraction unit 50 may be free to twist or turn about its axis in response to ambient air currents, or it may be rotatably motor driven in one or alternating directions.

Solely for the purpose of providing a dimensional reference for one embodiment and not to limit the scope of the invention, one properly functioning embodiment of the invention had the following dimensions and parameters:
Height of housing 10: 34.5 cm
Each side of triangular covers 11, 12: 14.8 cm
Height of connector 23: 1.5 cm
Diameter of connector 23: 0.96 cm
Width of slot connector slot 26: 0.12 cm
Grating groove depth in CD 20, 21, 22 80 nm
Grating track pitch in CD 20, 21, 22 1600 nm

Although the specific grating dimensions in typical CDs work quite well to produce insect-repelling diffraction patterns from both ambient sunlight and artificial light from most types of bulb sources, other diffraction gratings serve the same purpose. Such gratings can be provided by conventional structures such as CDs, DVDs, BDs (blue ray discs), etc., or may be specially formed or designed for purposes of repelling insects in accordance with the present invention.

Although the diffraction patterns resulting from ambient sunlight (i.e., “white light”) are very effective in repelling compound-eyed insects, artificial light from incandescent bulbs, LEDs, fluorescent bulbs, and halogen bulbs also effects the repelling function quite satisfactorily when diffracted according to the present invention. It is to be noted that ultimate optimization of insect repulsion using moving diffraction patterns according to the invention may depend on the wavelengths of the utilized light source and the grating dimensions. Nevertheless, even without such ultimate optimization, substantially any light source used with diffraction gratings such as CDs as described and illustrated herein effectively and efficiently repels insects with compound eyes.

In the preferred embodiment of the invention three cascaded diffraction gratings are employed, typically but not necessarily in the form of CDs. It is to be understood that only one or two such gratings, or more than three such gratings, may be employed within the scope and principles of the invention. Although the preferred configuration effects movement of the gratings and the resulting diffraction patterns about vertical axes, it will be appreciated that the housing or frame can be disposed in substantially any orientation without departing from the principles of the invention. For example, if housing 10 is placed on its side such that the CDs 20, 21, 22 extend horizontally between covers 11 and 12, the resulting moving diffraction patterns are still effective to repel insects with compound eyes.

The invention has been described above with the top and bottom covers supported between three parallel posts 13, 14, 15. It is to be understood that any number of posts, including only one, may be so used within the scope and principles of the invention. For example, if a single post is so used is might extend between covers 11 and 12 in a location laterally displaced from the common rotation axis of the diffraction gratings.

As noted herein, although the invention has been disclosed with primary application for repelling flies, the principles are equally applicable for repelling any insect having compound eye structures.

Having described preferred embodiments of new and improved methods and apparatus for repelling compound-eyed flying insects, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

I claim:

1. A method of repelling compound-eyed flying insects from a selected environment, said method comprising the steps of:
(a) positioning a movable structure having at least one surface with a diffraction grating defined therein within said selected environment;
(b) exposing said diffraction grating to light to cause diffraction patterns of the light to be formed by and emanate from said diffraction grating; and
(c) enabling movement of said movable structure to cause said diffraction patterns to move in said selected environment.

2. The method of claim 1 wherein step (a) comprises supporting said structure in an open-sided housing frame within which said structure is movable and through which the moving diffraction patterns of light can pass.

3. The method of claim 2 wherein step (c) comprises suspending said structure in said frame such that air currents cause movement of the structure.

4. The method of claim 2 wherein step (c) comprises imparting movement to said structure with a selectively actuable motor.

5. The method of claim 1 wherein said movable structure is a compact disc, and wherein step (a) includes suspending said compact disc in a frame in a manner permitting the compact disc to rotate about an axis extending diametrically through the compact disc.

6. The method of claim 1 wherein said movable structure is an assembly of cascaded compact discs, each compact disc having at least one surface with the diffraction grating defined therein, and wherein step (a) includes suspending said assembly in a manner permitting the compact discs therein to rotate about a common axis extending diametrically through each of said compact discs.

7. The method of claim 1 wherein step (a) includes suspending said movable structure in a frame in a manner permitting the structure to rotate about an axis extending therethrough.

8. The method of claim 1 wherein said movable structure is an assembly of plural diffraction grating structures, and step (a) includes suspending said assembly such that the gratings are secured to face in different directions and all of the gratings rotate in unison.

9. The method of claim 1 wherein said surface is reflective and wherein step (b) comprises causing the diffraction patterns of the light to be reflective diffraction patterns.

10. Apparatus for repelling compound-eyed flying insects from a selected environment comprising:
a housing;
a movable structure having at least one surface with a diffraction grating defined therein movably supported in said housing;
wherein said housing is configured to permit diffraction patterns of light emanating from said diffraction grating to egress from said housing.

11. The apparatus of claim 9 further comprising a motor disposed in said housing operatively connected to selectively move said movable structure and said diffraction patterns.

12. The apparatus of claim 10 wherein said housing comprises an open sided frame having top and bottom covers with a plurality of angularly spaced parallel posts extending between said covers.

13. The apparatus of claim 10 wherein said movable structure is a compact disc having at least one surface with the diffraction grating defined therein suspended within the housing to rotate about an axis extending diametrically through the compact disc.

14. The apparatus of claim 10 wherein said movable structure is an assembly of cascaded compact discs suspended in the housing to rotate about a common axis extending diametrically through each of said compact discs, each compact disc having at least one surface with the diffraction grating defined therein.

15. The apparatus of claim 14 further comprising a motor disposed in said housing and operatively connected to rotatably move said assembly.

16. The apparatus of claim 10 wherein said movable structure is an assembly of diffraction gratings suspended to be movable in the housing, wherein said surface is reflective, and wherein the diffraction patterns of light are reflective diffraction patterns.

17. The apparatus of claim 10 further comprising suction cups secured to said housing for enabling the housing to be mounted on a vertical surface.

18. Apparatus for repelling compound-eyed flying insects from a selected environment comprising:
a housing open at its sides comprising top and bottom covers with at least one support post extending therebetween; and
a structure having at least one light-reflective surface suspended from said top cover to be movable in said housing such that light reflected from said surface moves in said environment as said structure moves.

19. The apparatus of claim 18 wherein said structure comprises an assembly of cascaded discs, each having a reflective surface, suspended in the housing to rotate as a unit about a common axis extending diametrically through each of said discs, wherein the discs are secured to one another such that the reflective surfaces of the discs face in mutually different directions.

20. The apparatus of claim 19 further comprising a motor disposed in said housing and operatively connected to rotatably move said assembly.
